(19) United States
(12) Patent Application Publication
(10) Pub. No.: US 2006/0250070 A1
(43) Pub. Date: Nov. 9, 2006

(54) Vacuum vessel and electron emission display device using the same

(76) Inventors: Hyeong-Rae Seon, Suwon-si (KR); Dong-Su Chang, Suwon-si (KR); Gi-Young Song, Suwon-si (KR)

Correspondence Address: CHRISTIE, PARKER & HALE, LLP, PO BOX 7068, PASADENA, CA, 91109-7068, US

(21) Appl. No.: 11/351,442

(22) Filed: Feb. 9, 2006

(30) Foreign Application Priority Data
Apr. 29, 2005 (KR) 10-2005-0035984

(51) Int. Cl. H01J 63/04; H01J 1/62

(52) U.S. Cl. 313/495

(57) ABSTRACT

A vacuum vessel includes first and second substrates facing each other with a predetermined distance therebetween, a sealing member placed at peripheries of the first and second substrates to seal the first and second substrates to each other, and a getter provided between the first and second substrates. The getter has an active metal, a getter receptacle for containing the active metal, and a support for holding the getter receptacle between the first and second substrates. The getter receptacle is spaced substantially equidistance from the first and second substrates. A diffusion intercepting plate is formed at an end of the support directed toward the center of the first and second substrates in a body of the vacuum vessel.

### CROSS REFERENCE TO RELATED APPLICATION

This application claims priority to and the benefit of Korean Patent Application No. 10-2005-0035984, filed with the Korean Intellectual Property Office on Apr. 29, 2005, the entire content of which is incorporated herein by reference.

### BACKGROUND OF THE INVENTION

1. Field of the Invention

The present invention relates to a vacuum vessel, and in particular, to a vacuum vessel (or chamber) having a built-in getter that can be exhausted into a high vacuum state, and an electron emission display device using the vacuum vessel.

2. Description of Related Art

Generally, electron emission devices are classified into those using hot cathodes as an electron emission source, and those using cold cathodes as the electron emission source. There are several types of cold cathode electron emission devices, including a field emitter array (FEA) type, a metal-insulator-metal (MIM) type, a metal-insulator-semiconductor (MIS) type, and a surface conduction emitter (SCE) type.

An electron emission device can be used as an electron emission structure for a light emission source such as a backlight or for an image display device. Typically, in an electron emission display device using the electron emission device, first and second substrates face each other, and electron emission regions are formed on the first substrate together with driving electrodes for controlling the emission of electrons from the electron emission regions. Phosphor layers, and an anode electrode for placing the phosphor layers in a high potential state are formed on a surface of the second substrate facing the first substrate.

The first and second substrates are sealed to each other at their peripheries using a sealing member, such as a frit, and the inner space between the substrates is exhausted to form a vacuum vessel in order to smoothly emit and migrate electrons. A plurality of spacers are mounted within the vacuum vessel to space the first and second substrates from each other with a predetermined distance under the pressure applied to the vacuum vessel.

After the exhausting of the vacuum vessel, a gettering process is conducted with respect thereto to place the interior of the vacuum vessel in a high vacuum state. The gettering process includes evaporating an active metal, such as barium and/or magnesium charged within a getter receptacle; and chemically adsorbing and removing the gaseous molecules remaining within the vacuum vessel.

That is, when the getter receptacle mounted on the first substrate or the second substrate is heated through a high frequency-induced heating process or a laser heating process, the active metal, such as barium, charged in the getter receptacle is evaporated to thereby form a film, and the remaining gas such as hydrogen, carbon dioxide, oxygen, and steam is adsorbed by the film so that the interior of the vacuum vessel is kept (or placed) in the high vacuum state required for smooth electron emission.

During the gettering process, the getter receptacle is heated to 900° C. or more by the generated heat, and due to the generated heat, the first and/or second substrates mounted with the getter receptacle may be cracked, or otherwise broken. In addition, a part of the active metal evaporated during the gettering process may be scattered to the metallic electrodes such that the metallic electrodes may be short-circuited by the scattered part.

### SUMMARY OF THE INVENTION

In an exemplary embodiment of the present invention, there is provided a vacuum vessel which deters substrate breakage(s) due to heat generated from a getter receptacle and inter-electrodes short-circuiting due to an evaporated active metal, and an electron emission display device using the vacuum vessel.

In one exemplary embodiment of the present invention, the vacuum vessel includes first and second substrates facing each other with a predetermined distance therebetween, a sealing member placed at peripheries of the first and second substrates to seal them to each other, and a getter provided between the first and second substrates. The getter has an active metal, a getter receptacle for containing the active metal, and a support for holding the getter receptacle between the first and second substrates.

The getter receptacle may be spaced substantially equidistance from the first and second substrates.

The getter has a diffusion intercepting plate at an end thereof directed toward the center of the first and second substrates. The diffusion intercepting plate has a width corresponding to a region of the active metal diffusing toward the center of the first and second substrates.

The getter receptacle, the support and the diffusion intercepting plate may be formed with a material having a thermal expansion coefficient from about 8.5 to 9.0 ppm/° C. similar to that of the first and second substrates.

In another exemplary embodiment of the present invention, the electron emission display device includes first and second substrates facing each other with a predetermined distance therebetween. The first and second substrates have an active area, and a non-active area externally surrounding the active area. A sealing member forms a vacuum vessel together with the first and second substrates. An electron emission unit is provided at the active area of the first substrate. A light emission unit is provided at the active area of the second substrate. A getter is provided between the first and second substrates at the non-active area thereof. The getter has an active metal, a getter receptacle for containing the active metal, and a support for holding the getter receptacle between the first and second substrates.

### BRIEF DESCRIPTION OF THE DRAWINGS

FIG. 1 is a partial exploded perspective view of a vacuum vessel according to a first embodiment of the present invention.

FIG. 2 is a partial sectional view of the vacuum vessel according to the first embodiment of the present invention.

FIG. 3 is a partial exploded perspective view of a vacuum vessel according to a second embodiment of the present invention.

FIG. 4 is a partial sectional view of the vacuum vessel according to the second embodiment of the present invention.

FIG. 5 is a partial sectional view of the vacuum vessel according to the second embodiment of the present invention for illustrating the vacuum vessel during the gettering state.

FIG. 6 is a partial exploded perspective view of an FEA type electron emission display device using a vacuum vessel according to an embodiment of the present invention.

FIG. 7 is a partial sectional view of an FEA type electron emission display device using a vacuum vessel according to an embodiment of the present invention.

FIG. 8 is a partial sectional view of an SCE type electron emission display device using a vacuum vessel according to an embodiment of the present invention.

### DETAILED DESCRIPTION

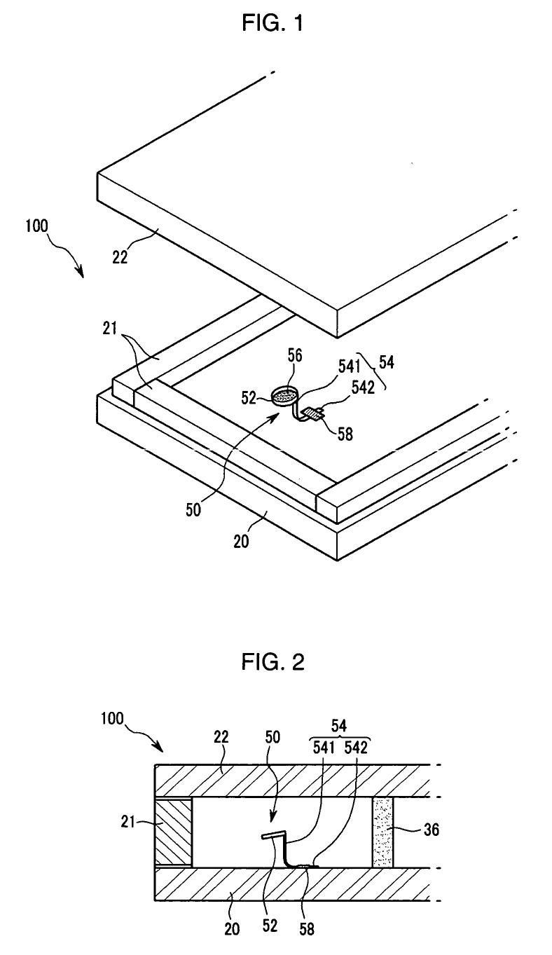

As shown in FIGS. 1 and 2, a vacuum vessel 100 according to a first embodiment of the present invention includes first and second substrates 20 and 22 facing each other with a predetermined distance therebetween, a sealing member 21 provided at the peripheries of the first and second substrates 20 and 22 to seal them to each other, and a getter 50 mounted at a one-sided corner area between the first and second substrates 20 and 22. The getter 50 has an active metal 56, a getter receptacle 52 containing the active metal 56, and a support 54 for supporting (or holding) the getter receptacle 52 between the first and second substrates 20 and 22.

The getter receptacle 52 and the support 54 are formed with a material having a thermal expansion coefficient from 8.5 to 9.0 ppm/° C. similar to that of the first and second substrates 20 and 22. Accordingly, the getter receptacle 52 is deterred from being displaced due to the thermal expansion of the getter receptacle 52, the support 54, and the first and second substrates 20 and 22, thereby allowing the getter receptacle 52 to properly perform its role at the predetermined location.

In FIGS. 1 and 2, the support 54 of the getter 50 is shown to be fixed to the first substrate 20 via a fixation member 58, such as a frit or an adhesive. Alternatively, the getter support 54 may be fixed to the second substrate 22. The getter support 54 is formed with a vertical portion 541 for supporting the getter receptacle 52, and a horizontal portion 542 for fixing to the first substrate 20 or the second substrate 22.

The height of the support 54 is established such that the getter receptacle 52 is spaced substantially equidistance from the first and second substrates 20 and 22. Since the getter receptacle 52 is not spatially biased toward the first substrate 20 or the second substrate 22 even when the getter receptacle 52 is heated during the gettering process (because the generated heat does not induce any local (or independent) thermal expansion), the occurrence of cracks at the first and second substrates 20 and 22 can effectively be prevented.

In one embodiment, a barium and/or magnesium material is used as the active metal 56 of the getter 50.

Although only one getter 50 is illustrated in the vacuum vessel 100 of FIGS. 1 and 2, when needed, a plurality of getters 50 may be provided within the vacuum vessel 100. The getter 50 is located at the corner area of the vacuum vessel 100 such that the evaporated active metal is not diffused toward the center of the vacuum vessel 100. For instance, the getter 50 may be provided between a spacer 36 for spacing the first and second substrates 20 and 22 from each other with a predetermined distance therebetween, and the sealing member 21.

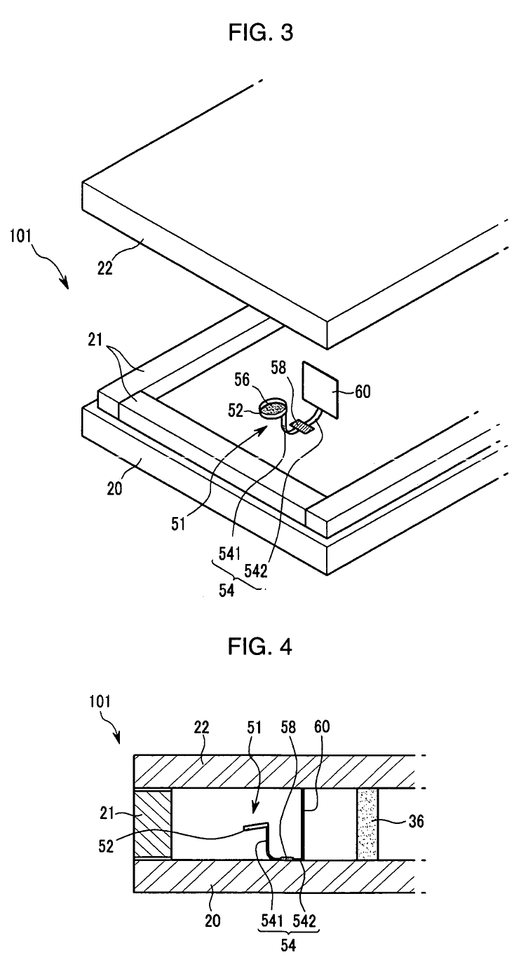

FIGS. 3 and 4 show a vacuum vessel 101 according to a second embodiment of the present invention. In the vacuum vessel 101 of FIGS. 3 and 4, a getter 51 has a diffusion intercepting plate 60 at the end thereof directed toward the center of the vacuum vessel 101 to intercept the diffusion of the active metal. The diffusion intercepting plate 60 is located at the route of the diffusion of the active metal during the gettering process, and has a height corresponding to the distance between the first and second substrates 20 and 22, and a width from about 1 to 3 cm.

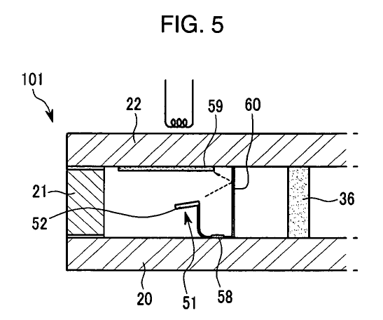

As shown in FIGS. 3, 4, and 5, the active metal 56 contained in the getter receptacle 52 is evaporated during the gettering process, and forms a getter film 59 on the first substrates 20 and/or the second substrate 22, for instance, on the second substrate 22. The diameter of the getter film 59 may be about 1 cm. The diffusion intercepting plate 60 has a width (or area) corresponding to the area (or region) of diffusion of the active metal 56 (or active material) toward the center of the first and second substrates 20 and 22 such that the diffusion intercepting plate 60 can intercept (or block) the diffusion of the active metal 56 toward the center of the vacuum vessel 101.

In FIGS. 3, 4, and 5, the diffusion intercepting plate 60 is shown to be integrated with the support 54 of the getter 51. Alternatively, the diffusion intercepting plate 60 may be separately formed irrespective of the support 54, and fixed to the first substrate 20 and/or the second substrate 22 using a fixation member, such as a frit or an adhesive. Furthermore, as with the getter receptacle 52 and the support 54, the diffusion intercepting plate 60 may be formed with a material having a thermal expansion coefficient from about 8.5 to 9.0 ppm/° C. similar to that of the first and second substrates 20 and 22.

With the vacuum vessels 100 and 101 according to the first and second embodiments, an electron emission unit is provided on a surface of the first substrate 20 facing the second substrate 22, and a light emission unit is provided on a surface of the second substrate 22 facing the first substrate 20, thereby constructing an electron emission display device. When the area of the electron emission unit and the light emission unit of the vacuum vessel 100 or 101 is defined as an active area, the getter 50 or 51 is located at the non-active area surrounding the active area, and the diffusion intercepting plate 60 is located at the end of the getter 51 directed toward the active area.

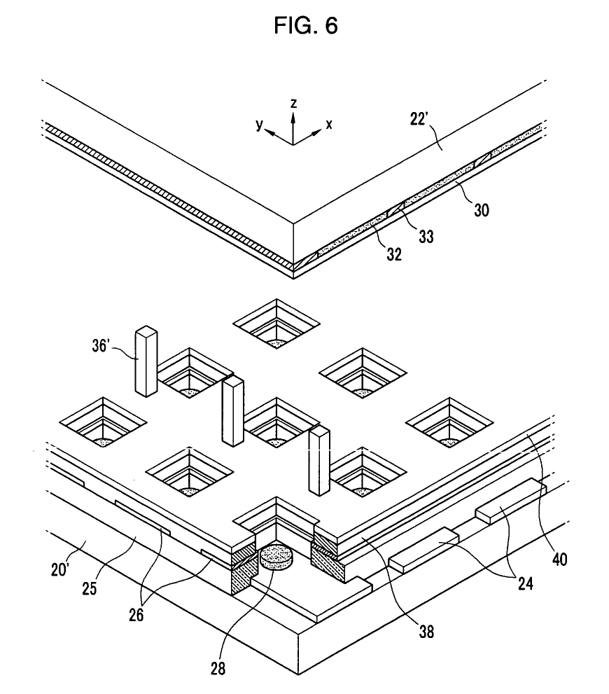

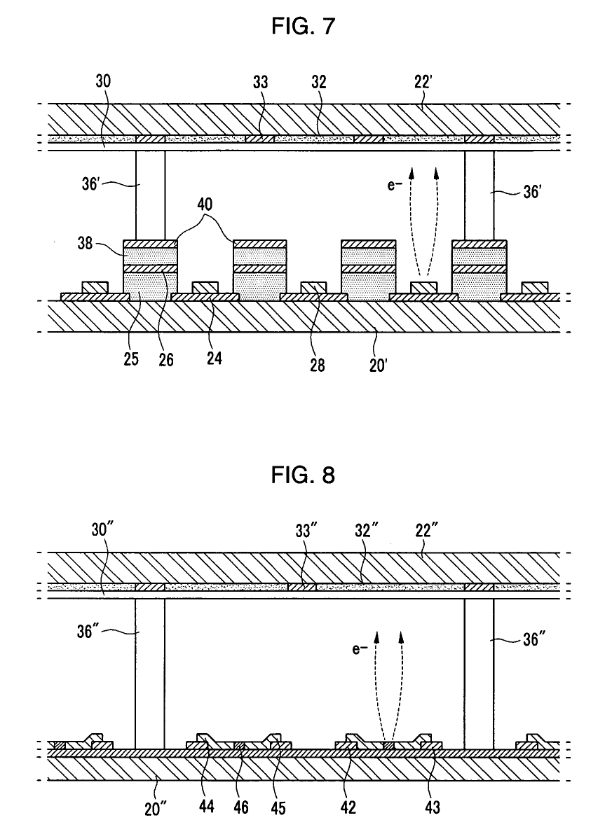

An FEA type electron emission display device having a vacuum vessel in accordance with an embodiment of the present invention will be described with reference to FIGS. 6 and 7, and an SCE type electron emission display device having a vacuum vessel in accordance with an embodiment of the present invention will be described with reference to FIG. 8.

With the FEA type electron emission display device shown in FIGS. 6 and 7, cathode electrodes 24 are patterned into a plurality of stripes on a first substrate 20′ in a first direction and can be referred to as first electrodes, and a first insulating layer 25 is formed on the entire surface of the first substrate 20′ while covering the cathode electrodes 24. Gate electrodes 26 are patterned into a plurality of stripes on the first insulating layer 25 crossing over the cathode electrodes 24 and can be referred to as second electrodes.

Electron emission regions 28 are formed on the cathode electrodes 24 at respective crossed regions of the cathode and gate electrodes 24 and 26. Openings are formed at the first insulating layer 25 and the gate electrodes 26 corresponding to the respective electron emission regions 28 to expose the electron emission regions 28 on the first substrate 20′.

In this embodiment, the electron emission regions 28 are formed with a material for emitting electrons when an electric field is applied thereto under a vacuum state (or atmosphere), such as a carbonaceous material and/or a nanometer-sized material. The electron emission regions 28 may be formed with carbon nanotube, graphite, graphite nanofiber, diamond, diamond-like carbon, C₆₀, silicon nanowire or a combination thereof, by way of screen-printing, direct growth, chemical vapor deposition, and/or sputtering.

In FIGS. 6 and 7, the gate electrodes 26 are formed over the cathode electrodes 24 while interposing the first insulating layer 25 therebetween. However, it is also possible to place the gate electrodes 26 under the cathode electrodes 24 while interposing the first insulating layer 25 therebetween. In this case, the electron emission regions 28 may electrically contact a lateral surface of the cathode electrodes 24 on the first insulating layer 25.

Also, in FIGS. 6 and 7, a focusing electrode 40 is formed on the gate electrodes 26 and the first insulating layer 25 and can be referred to as a third electrode. A second insulating layer 38 is placed under the focusing electrode 40 to insulate the gate electrodes 26 from the focusing electrode 40, and openings are formed at the second insulating layer 38 and the focusing electrode 40 to allow electron beams from the electron emission regions 28 to pass through.

Phosphor layers 32 and black layers 33 are formed on a surface of a second substrate 22′ facing the first substrate 20′, and an anode electrode 30 is formed on (or under) the phosphor layers 32 and the black layers 33 with a metallic material, such as aluminum. The anode electrode 30 receives a high voltage required for accelerating the electron beams, and places the phosphor layers 32 in a high potential state. The anode electrode 30 reflects the visible rays radiating from the phosphor layers 32 toward the first substrate 20′ to the second substrate 22′, thereby heightening the screen luminance.

Alternatively, an anode electrode may be formed with a transparent conductive material, such as indium tin oxide (ITO), instead of the metallic material. In this case, the anode electrode is placed on a surface of phosphor layers and black layers facing a second substrate. Furthermore, an anode electrode may be formed with a double-layered structure having a transparent conductive material-based layer and a metallic material-based layer.

Referring still to FIGS. 6 and 7, spacers 36′ are arranged between the first and second substrates 20′ and 22′ to support the vacuum vessel under the pressure applied thereto, and to space the first and second substrates 20′ and 22′ apart from each other with a predetermined distance therebetween. The spacers 36′ are located to correspond to the black layers 33 such that they do not occupy the area of the phosphor layers 32.

When a scan driving voltage is applied to the cathode electrodes 24 and a data driving voltage to the gate electrodes 26 (or when a scan driving voltage is applied to the gate electrodes 26 and a data driving voltage to the cathode electrodes 24), an electric field is formed around the electron emission regions 28, and electrons are emitted from the electron emission regions 28. The emitted electrons are focused at the center of a bundle of electron beams while passing through the openings of the focusing electrode 40, and attracted by the high voltage applied to the anode electrode 30, thereby colliding with the phosphor layers 32 at the relevant pixels to emit light.

With an SCE type electron emission display device shown in FIG. 8, first and second electrodes 42 and 43 are arranged on a first substrate 20″ parallel to each other, and first and second conductive thin films 44 and 45 are placed close to each other while partially covering the surface of the first and second electrodes 42 and 43. Electron emission regions 46 are disposed between the first and second conductive thin films 44 and 45 such that they are electrically connected to the thin films 44 and 45.

The first and second electrodes 42 and 43 may be formed with various conductive materials. The first and second conductive thin films 44 and 45 may be formed with micro particles using a conductive material, such as nickel (Ni), gold (Au), platinum (Pt), and/or palladium (Pd). The electron emission regions 46 may be formed with high resistance cracks placed between the first and second conductive thin films 44 and 45, and/or formed to have carbon and/or one or more carbon compounds.

As with the structure of the FEA type electron emission display device, phosphor layers 32″, black layers 33″ and an anode electrode 30″ are formed on a surface of a second substrate 22″.

With the above structure, when voltages are applied to the first and second electrodes 42 and 43, an electric current is flown through the first and second conductive thin films 44 and 45 horizontal to the surface of the electron emission regions 46, thereby making a surface-conduction type electron emission. The emitted electrons are attracted by the high voltage applied to the anode electrode 30″, and migrated toward the second substrate 22″, thereby colliding against the relevant phosphor layers 32″ to emit light.

With the above-structured electron emission display device, an electron emission unit is formed at an active area of a first substrate (e.g., 20, 20′, and/or 20″), and a light emission unit is formed at an active area of a second substrate (e.g., 22, 22′, and/or 22″). The first and second substrates are sealed to each other using a sealing member (e.g., 21), and the interior thereof is exhausted. A getter receptacle (e.g., 52) is heated through a high frequency-induced heating or a laser heating, thereby initiating the gettering process.

With the gettering process, an active metal (e.g., 56) contained in the getter receptacle is evaporated to thereby form a getter film (e.g., 59). The getter film adsorbs the remnant (or remaining) gas, and enhances the vacuum degree in the vacuum vessel. Since the diffusion of the active metal toward the electron emission unit and the light emission unit during the evaporation of the active metal is intercepted by a diffusion intercepting plate (e.g., 60), the getter film is not formed at (or scattered to) the electron emission unit or the light emission unit.

Although, it is explained above that a vacuum vessel according to an embodiment of the present invention is applied to an FEA type electron emission display device and an SCE type electron emission display device, an electron emission display device according to the present invention is not limited thereto.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A vacuum vessel comprising:
first and second substrates facing each other with a predetermined distance therebetween;
a sealing member placed at peripheries of the first and second substrates to seal the first and second substrates to each other; and
a getter provided between the first and second substrates;
wherein the getter comprises an active metal, a getter receptacle for containing the active metal, and a support for holding the getter receptacle between the first and second substrates.

2. The vacuum vessel of claim 1, wherein the getter receptacle is spaced substantially equidistance from the first and second substrates.

3. The vacuum vessel of claim 1, wherein the getter is placed at a corner area of the first and second substrates.

4. The vacuum vessel of claim 1, wherein the getter receptacle and the support have a thermal expansion coefficient from about 8.5 to 9.0 ppm/° C.

5. The vacuum vessel of claim 1, wherein the support is fixed to the first substrate or the second substrate using a fixation member.

6. The vacuum vessel of claim 1, wherein the getter has a diffusion intercepting plate at an end thereof directed toward the center of the first and second substrates.

7. The vacuum vessel of claim 6, wherein the diffusion intercepting plate has a width corresponding to a region of the active metal diffusing toward the center of the first and second substrates.

8. The vacuum vessel of claim 6, wherein the diffusion intercepting plate is integrated with the support.

9. The vacuum vessel of claim 6, wherein the diffusion intercepting plate has a thermal expansion coefficient from about 8.5 to 9.0 ppm/° C.

10. An electron emission display device comprising:
first and second substrates facing each other with a predetermined distance therebetween, the first and second substrates having an active area and a non-active area externally surrounding the active area;
a sealing member forming a vacuum vessel together with the first and second substrates;
an electron emission unit provided at the active area of the first substrate;
a light emission unit provided at the active area of the second substrate; and
a getter provided between the first and second substrates at the non-active area thereof;
wherein the getter comprises an active metal, a getter receptacle for containing the active metal, and a support for holding the getter receptacle between the first and second substrates.

11. The electron emission display device of claim 10, wherein the getter receptacle is spaced substantially equidistance from the first and second substrates.

12. The electron emission display device of claim 10, wherein the first and second substrates as well as the getter receptacle and the support have a thermal expansion coefficient from about 8.5 to 9.0 ppm/° C.

13. The electron emission display device of claim 10, wherein the getter has a diffusion intercepting plate at an end thereof directed toward the active area of the first and second substrates.

14. The electron emission display device of claim 13, wherein the diffusion intercepting plate has a width corresponding to a region of the active metal diffusing toward the active area of the first and second substrates.

15. The electron emission display device of claim 13, wherein the diffusion intercepting plate has a thermal expansion coefficient from about 8.5 to 9.0 ppm/° C.

16. A vacuum vessel of an electron emission display device comprising:
a first substrate;
a second substrate;
an active metal;
a getter receptacle for containing the active metal; and
a support for holding the getter receptacle between the first substrate and the second substrate to deter a spatial bias.

17. The vacuum vessel of claim 16, wherein the first and second substrates as well as the getter receptacle and the support have a thermal expansion coefficient from about 8.5 to 9.0 ppm/° C.

18. The vacuum vessel of claim 16, further comprising a diffusion intercepting plate coupled to an end of the support directed toward the center of at least one of the first substrate or the second substrate.
